(19) United States
(12) Patent Application Publication
(10) Pub. No.: US 2025/0170987 A1
(43) Pub. Date: May 29, 2025

(54) Control Device and Method for Deactivating an Activated Anti-theft Function of a Vehicle Component of a Motor Vehicle

(71) Applicant: Bayerische Motoren Werke Aktiengesellschaft, Muenchen (DE)

(72) Inventors: Andrew GRENZENDORF, Muenchen (DE); Johann HARTOK, Grossmehring (DE); Niklas SCHWELLENBACH, Woerth (DE)

(21) Appl. No.: 18/940,941

(22) Filed: Nov. 8, 2024

(30) Foreign Application Priority Data
Nov. 23, 2023 (DE) 10 2023 132 714.3

(51) Int. Cl. B60R 25/20; B60R 16/023

(52) U.S. Cl. CPC B60R 25/20; B60R 16/023

(57) ABSTRACT

A control device configured to deactivate an activated anti-theft function of a vehicle component of a motor vehicle is provided. The control device determines whether a previously determined event has occurred and, in such a case, deactivates the activated anti-theft function of the vehicle component.

### CROSS REFERENCE TO RELATED APPLICATION

This application claims priority under 35 U.S.C. § 119 from German Patent Application No. DE 10 2023 132 714.3, filed Nov. 23, 2023, the entire disclosure of which is herein expressly incorporated by reference.

### BACKGROUND AND SUMMARY

The present disclosure relates to a control device for deactivating an activated anti-theft function of a vehicle component of a motor vehicle, to a motor vehicle having the control device and/or to a method for deactivating an activated anti-theft function of a vehicle component of a motor vehicle. In addition, or as an alternative, a computer program product is provided, which comprises commands which, when the program is executed by a computer, cause the computer to execute the method at least in part. In addition, or as an alternative, a non-transitory computer-readable medium is provided, which comprises commands which, when the commands are executed by a computer, cause the computer to execute the method at least in part.

Certain vehicle components are equipped with anti-theft functions and are thus largely protected against theft.

The use of anti-theft functions for vehicle components is known from the prior art. DE 10 2015 117 317 A1 describes a headlight with anti-theft protection, a vehicle having the headlight and a method for activating an anti-theft function.

However, such an anti-theft function prevents the selling of functional vehicle components, for example, as a result of total economic loss of the motor vehicle. This may result in a disadvantage for the motor vehicle owner.

Against the background of this prior art, the object of the present disclosure is to specify a device and/or a method which are suitable for enhancing the prior art.

The object is achieved by the features of the independent claims. The content of each of the subordinate claims and the dependent claims is optional developments.

The object is accordingly achieved by a control device for deactivating an activated anti-theft function of a vehicle component of a motor vehicle. The control device is designed to ascertain whether a previously determined event has occurred and to deactivate the activated anti-theft function of the vehicle component if the previously determined event has occurred.

For example, the control device may be an electronic control unit (ECU). The electronic control unit may be an intelligent processor-controlled unit, which can communicate with other modules, for example. via a central gateway (CGW), and which may form the vehicle on-board electrical system by means of field buses, such as the CAN bus, LIN bus, MOST bus, FlexRay and/or via the automotive Ethernet, for example, together with telematics control units and/or an environmental sensor system.

However, the control device does not necessarily have to be part of the motor vehicle. It is also conceivable that the control device is arranged partially or completely outside the motor vehicle and is connected to the motor vehicle, optionally wirelessly.

It is also conceivable that the control device is arranged partially or completely within the vehicle component.

When the vehicle component is first installed in the motor vehicle, the vehicle component can be cryptographically coupled to the motor vehicle. In other words, when the vehicle component is first installed in the motor vehicle, the anti-theft function of the vehicle component can be activated. The vehicle component that is coupled to the motor vehicle is thus assigned to this motor vehicle.

The activated anti-theft function of the vehicle component may result in the motor vehicle no longer being able to be started after the vehicle component has been removed from the motor vehicle without first deactivating the anti-theft function. The activated anti-theft function of the vehicle component may result in the vehicle component not being able to be used in other motor vehicles, or being able to be used only with limited functionality. For example, the activated anti-theft function of the vehicle component can prevent the starting of another motor vehicle in which the vehicle component has been installed.

The vehicle component may, for example, be a vehicle headlight, an engine control unit, a battery, a battery control unit or another vehicle component, for example, another component of the drive train of the motor vehicle.

The control device may be designed to detect the activated anti-theft function of the vehicle component by way of a signal originating from the vehicle component. The signal can be transmitted via an, optionally encrypted, connection between the vehicle component and the motor vehicle, for example, via a fieldbus. The signal may contain information about whether or not the vehicle component is associated with the motor vehicle. In other words, the signal may contain information about the existence or non-existence of a coupling between the vehicle component and the motor vehicle. The signal may be an electrical signal.

The occurrence of the previously determined event may be a state of the vehicle component and/or the motor vehicle that can be recognized by the control device. In other words, the control device may be designed to ascertain whether the previously determined event has occurred on the basis of motor-vehicle-specific and/or vehicle-component-specific actual data and/or motor-vehicle-specific and/or vehicle-component-specific target data.

The control device may be designed to automatically deactivate the activated anti-theft function of the vehicle component if the previously determined event has occurred.

The control device may have a data connection to the vehicle component. The control device may have a data connection to the vehicle component by means of a cable.

The device described above offers a number of advantages in this case. Among other things, it is possible for the motor vehicle owner to make an independent decision about the further use and/or reuse of the vehicle components. For example, the motor vehicle owner can remove used vehicle components from the motor vehicle and resell them. This is particularly advantageous for the motor vehicle owner after a total economic loss of the motor vehicle, for example, as a result of an accident.

The vehicle component may have a storage module for storing the vehicle-component-specific actual data and/or the vehicle-component-specific target data. The target-data can be written to the storage module during the manufacture of the vehicle component. The vehicle-component-specific actual data can be written to the storage module during the operation of the motor vehicle and/or the vehicle component, for example, by the control device.

The control device may have a detection unit for detecting the activated anti-theft function of the vehicle component. For example, the control device and/or the detection unit can communicate with the vehicle component and detect whether the anti-theft function of the vehicle component is activated. It is conceivable that the control device and/or the detection unit detects/detect the activated anti-theft function by way of the signal coming from the vehicle component.

The control device may have a storage unit for storing motor-vehicle-specific actual data and/or motor-vehicle-specific target data. The target data can be written to the storage unit during the manufacture of the motor vehicle. The motor-vehicle-specific actual data can be written to the storage unit during the operation of the motor vehicle, for example by the control device.

The control device may have a readout unit for reading out motor-vehicle-specific and/or vehicle-component-specific actual data and/or motor-vehicle-specific and/or vehicle-component-specific target data.

The control device and/or the readout unit may be designed to read out motor-vehicle-specific and/or vehicle-component-specific actual data. For example, the control device and/or the readout unit may be designed to read out the vehicle-component-specific actual data and/or the vehicle-component-specific target data from the storage module of the vehicle component. Optionally, the control device and/or the readout unit may be designed to read out the motor-vehicle-specific actual data and/or the motor-vehicle-specific target data from the storage unit.

The motor-vehicle-specific actual data may include information about the mileage of the motor vehicle and/or about the age of the motor vehicle at the time of reading out the motor-vehicle-specific actual data. The vehicle-component-specific actual data may include information about the age of the vehicle component at the time of reading out the vehicle-component-specific actual data.

The motor-vehicle-specific target data may include information about a previously determined mileage of the motor vehicle and/or about a previously determined age of the motor vehicle. The vehicle-component-specific target data may include information about a previously determined age of the vehicle component.

The control device may have a comparison unit for comparing the motor-vehicle-specific and/or the vehicle-component-specific actual data with the motor-vehicle-specific and/or the vehicle-component-specific target data.

The control device and/or the comparison unit may be designed to compare the motor-vehicle-specific and/or vehicle-component-specific actual data with the motor-vehicle-specific and/or vehicle-component-specific target data. The control device and/or the comparison unit may be designed to store a comparison result from the comparison of the motor-vehicle-specific and/or vehicle-component-specific actual data with the motor-vehicle-specific and/or vehicle-component-specific target data, for example in the storage unit of the control device.

The control device may be designed to ascertain whether the previously determined event has occurred depending on the comparison result.

Possible further developments of the device described above are explained in detail below.

The control device may be designed to deactivate the activated anti-theft function of the vehicle component by canceling a cryptographically protected coupling between the vehicle component and the motor vehicle.

The cryptographically protected coupling can be understood to mean an encrypted coupling. The cryptographically protected coupling enables signals and/or messages and/or data to be sent in encrypted form. Encryption and decryption of signals and/or messages and/or data can be performed by means of cryptographic keys. The cryptographic key may be a bit sequence. The cryptographic key may have a length of one or more bits and/or bytes.

The cryptographically protected coupling can be established by means of symmetrical encryption. Symmetrical cryptography encryption methods work with a single, secret cryptographic key that must be present in the encryption and decryption of signals and/or messages and/or data.

The cryptographically protected coupling can be established by means of asymmetrical encryption. Asymmetrical cryptography encryption methods work with a public, non-secret cryptographic key and a private, secret cryptographic key that must be present in the encryption and decryption of signals and/or messages and/or data.

The cryptographically protected coupling between the vehicle component and the motor vehicle can be canceled by decoupling the cryptographic keys.

The cryptographically protected coupling between the vehicle component can be canceled by resetting the vehicle component and/or the motor vehicle to a non-coupled state by way of a token. In other words, the assignment of the vehicle component to the motor vehicle can be canceled by way of the token.

The token may be a hardware token or a software token. The token can store and transmit data that contain information for identification and authentication purposes.

It is conceivable that the token, for example a USB stick, can be connected to the motor vehicle by means of a suitable interface, for example, a USB port, so that data stored on the token that contain information for identification and authentication purposes and that enable the motor vehicle and the vehicle component to be decoupled from one another, can be transferred to the motor vehicle, for example, to the control device.

The previously determined event may include the control device receiving a release signal.

The control device may include a receiving unit for receiving the release signal. The control device and/or the receiving unit may be designed to receive the release signal.

The release signal can be generated by a user, such as the motor vehicle owner, for example. For this purpose, the motor vehicle owner can identify themselves, for example, by means of the token, via a user input unit, which is arranged, for example, on the motor vehicle and generate the release signal by performing an input on the user input unit.

The user input unit may be part of a user interface of a motor vehicle.

The control device may have a data connection to the user input unit.

A control device designed in this way offers a number of advantages. For example, a motor vehicle owner may decide at any time to remove certain vehicle components from the motor vehicle and to reuse them. This gives the motor vehicle owner greater flexibility and freedom in handling the components of their motor vehicle.

The previously determined event may include reaching a previously determined mileage of the motor vehicle.

The previously determined mileage may be a mileage of the motor vehicle in kilometers.

A control device designed in this way offers the advantage that vehicle components are automatically decoupled upon a previously determined mileage of the motor vehicle in kilometers being reached and can be reused without an active approval from a user, for example the motor vehicle owner, being required.

The previously determined event may include reaching a previously determined age of the vehicle component.

The age of the vehicle component may be a period in years and/or months and/or days. The period may start from the completion of the motor vehicle or from the first sale of the motor vehicle. In addition, or as an alternative, the start of the period can be defined by a user, for example the motor vehicle owner.

A control device designed in this way offers the advantage that vehicle components are automatically decoupled from the motor vehicle after the expiry of a previously determined waiting period. Due to the age of the vehicle component, the vehicle components can be reused without increasing the risk of vehicle component theft.

The previously determined event may include reaching a previously determined age of the motor vehicle.

The age of the motor vehicle may be a period in years and/or months and/or days. The period may start from the completion of the motor vehicle or from the first sale of the motor vehicle. In addition, or as an alternative, the start of the period can be defined by a user, for example, the motor vehicle owner.

According to one optional embodiment, the previously determined event may be a combination of the control device receiving a release signal and/or reaching a previously determined mileage of the motor vehicle and/or reaching a previously determined age of the vehicle component and/or reaching a previously determined age of the motor vehicle.

What is described above may be summarized in other words and with reference to a possible more concrete embodiment as described below, with the following description being interpreted as not limiting.

According to the disclosure, it is conceivable that cryptographically protected (vehicle) components can be removed from the entire system automatically or by customer request after the expiry of a waiting period of several years, for example, 10 years, or after the expiry of a certain mileage by decoupling the cryptographic keys or by resetting them by means of tokens, and can thus be reused or sold.

What has been described above enables the reuse of components protected against theft by explicit consent from the customer, by the age of the vehicle or after the expiry of a time that does not pose a risk of increasing the risk of theft.

In addition, a motor vehicle is provided with the control device described above. The motor vehicle may comprise the vehicle component described above.

The motor vehicle may be a passenger vehicle, in particular an automobile, or a commercial vehicle, such as a truck, for example.

What has been described above with reference to the control device also applies analogously to the motor vehicle and vice versa.

Furthermore, the invention provides a method for deactivating an activated anti-theft function of a vehicle component of a motor vehicle, wherein the method comprises: ascertaining whether a previously determined event has occurred and deactivating the activated anti-theft function of the vehicle component if the previously determined event has occurred.

The (control) method may be a computer-implemented method, that is to say one, several or all steps of the method can be carried out at least in part by a computer or a device for data processing, optionally the control device.

What has been described above with reference to the control device and to the motor vehicle also applies analogously to the method and vice versa.

The method may also comprise: reading out the motor-vehicle-specific and/or vehicle-component-specific actual data.

The method may also comprise: reading out the motor-vehicle-specific and/or vehicle-component-specific target data.

The method may also comprise: comparing the motor-vehicle-specific and/or vehicle-component-specific actual data with motor-vehicle-specific and/or vehicle-component-specific target data.

The method may also comprise: storing a comparison result from the comparison of the motor-vehicle-specific and/or vehicle-component-specific actual data with the motor-vehicle-specific and/or vehicle-component-specific target data.

Furthermore, a computer program is provided, comprising commands which, when the program is executed by a computer, cause the computer to execute or carry out at least in part the method described above.

A program code of the computer program may be present in any code, in particular in a code which is suitable for controlling motor vehicles.

What has been described above with reference to the control device, to the motor vehicle and to the method also applies analogously to the computer program and vice versa.

Furthermore, a non-transitory computer-readable medium, in particular a computer-readable storage medium, is provided. The computer-readable medium comprises commands which, when the commands are executed by a computer, cause the computer to execute or carry out at least in part the method described above.

This means that a computer-readable medium which comprises a computer program defined above may be provided. The computer-readable media may be any digital data storage unit, such as a USB stick, a hard drive, a CD-ROM, an SD card or an SSD card (or SSD drive/SSD hard drive), for example.

The computer program does not necessarily have to be stored on such a computer-readable storage medium in order to be made available to the vehicle, but may also be obtained via the Internet or otherwise externally.

What has been described above with reference to the method, to the control device, to the computer program and to the motor vehicle also applies analogously to the computer-readable medium and vice versa.

An optional embodiment is described below with reference to FIGS. 1 and 2.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 schematically shows a motor vehicle having a control device for deactivating an anti-theft function of a vehicle component according to the optional embodiment, and

FIG. 2 schematically shows a flowchart of a method for deactivating the anti-theft function of the vehicle component of the motor vehicle according to the optional embodiment.

### DETAILED DESCRIPTION OF THE DRAWINGS

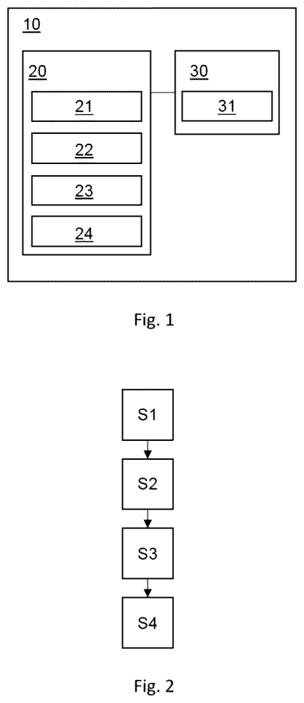

The motor vehicle 10 shown only schematically in FIG. 1 comprises a control device 20 and a vehicle component 30. The control device 20 has a data connection to the vehicle component 30.

The vehicle component 30 has a storage module 31 for storing vehicle-component specific actual data and/or vehicle-component specific target data.

The control device 20 comprises a detection unit 21 for detecting the activated anti-theft function of the vehicle component 30, a storage unit 22 for storing motor-vehicle specific actual data and motor-vehicle specific target data, a readout unit 23 for reading out the motor-vehicle specific and vehicle component-specific actual data and the motor-vehicle-specific and vehicle-component specific target data, and a comparison unit 24 for comparing the motor-vehicle-specific and the vehicle-component-specific actual data with the motor-vehicle-specific and the vehicle-component specific target data.

The control device 20 is designed to carry out the method described in detail below also with reference to FIG. 2.

The method shown in FIG. 2 as a flowchart comprises four method steps.

In a first method step S1, the control device 20 detects the activated anti-theft function by means of the detection unit 21 of the control device 20.

In a second method step S2, the control device 20 reads out the motor vehicle specific actual data and target data stored in the storage unit 22 and the vehicle component specific actual data and target data stored in the storage module 31 of the vehicle component 30. In the present case, the motor-vehicle-specific actual data include the age of the motor vehicle 10 at the time of readout and the motor-vehicle specific target data include a previously determined age of the motor vehicle 10. In the present case, the vehicle-component specific actual data include the age of the vehicle component 30 at the time of readout and the vehicle-component specific target data include a previously determined age of the vehicle component 30.

In a third method step S3, the control device 20 ascertains whether a previously determined event has occurred. In the present case, the predetermined event is the reaching of a previously determined age of the motor vehicle 10 and the vehicle component 30. For this purpose, the control device 20 uses the comparison unit 24 to compare the motor-vehicle specific actual data with the motor-vehicle specific target data and the vehicle-component specific actual data with the vehicle-component specific target data. If the age of the motor vehicle 10, which is stored in the motor-vehicle specific actual data, is greater than or equal to the previously determined age of the motor vehicle 10, which is stored in the motor-vehicle specific target data, and the age of the vehicle component 30, which is stored in the vehicle-component specific actual data, is greater than or equal to the previously determined age of the vehicle component 30, which is stored in the vehicle-component specific target data, the previously determined event has occurred.

In a fourth method step S4, the control device 20 deactivates the anti-theft function of the vehicle component 30 if it is ascertained in the third step S3 that the predetermined event has occurred.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

10 Motor vehicle
20 Control device
21 Detection unit
22 Storage unit
23 Readout unit
24 Comparison unit
30 Vehicle component
31 Storage module
S1-S4 Method steps of the method

What is claimed is:

1. A control device configured to deactivate an activated anti-theft function of a vehicle component of a motor vehicle, wherein the control device is configured to:
determine whether a previously determined event has occurred, and
deactivate the activated anti-theft function of the vehicle component in a case in which the previously determined event has occurred.

2. The control device according to claim 1, wherein the control device is configured to deactivate the activated anti-theft function of the vehicle component by canceling a cryptographically protected coupling between the vehicle component and the motor vehicle.

3. The control device according to claim 1, wherein the previously determined event comprises the control device receiving a release signal.

4. The control device according to claim 2, wherein the previously determined event comprises the control device receiving a release signal.

5. The control device according to claim 1, wherein the previously determined event comprises reaching a previously determined mileage of the motor vehicle.

6. The control device according to claim 2, wherein the previously determined event comprises reaching a previously determined mileage of the motor vehicle.

7. The control device according to claim 3, wherein the previously determined event comprises reaching a previously determined mileage of the motor vehicle.

8. The control device according to claim 1, wherein the previously determined event comprises reaching a previously determined age of the vehicle component.

9. The control device according to claim 2, wherein the previously determined event comprises reaching a previously determined age of the vehicle component.

10. The control device according to claim 3, wherein the previously determined event comprises reaching a previously determined age of the vehicle component.

11. The control device according to claim 1, wherein the previously determined event comprises reaching a previously determined age of the motor vehicle.

12. The control device according to claim 2, wherein the previously determined event comprises reaching a previously determined age of the motor vehicle.

13. The control device according to claim 3, wherein the previously determined event comprises reaching a previously determined age of the motor vehicle.

14. A motor vehicle comprising the control device according to claim 1.

15. The motor vehicle according to claim 14, wherein the control device is configured to deactivate the activated anti-theft function of the vehicle component by canceling a cryptographically protected coupling between the vehicle component and the motor vehicle.

16. The motor vehicle according to claim 14, wherein the previously determined event comprises the control device receiving a release signal.

17. A method for deactivating an activated anti-theft function of a vehicle component of a motor vehicle, the method comprising:
determining whether a previously determined event has occurred; and
deactivating the activated anti-theft function of the vehicle component in a case in which the previously determined event has occurred.

18. A non-transitory computer-readable medium comprising commands which, when executed by a computer, cause the computer to execute a method according to claim 17.

19. The non-transitory computer-readable medium according to claim 18, wherein the commands cause the computer to deactivate the activated anti-theft function of the vehicle component by canceling a cryptographically protected coupling between the vehicle component and the motor vehicle.

20. The non-transitory computer-readable medium according to claim 18, wherein the previously determined event comprises the control device receiving a release signal.
